(19) United States
(12) Patent Application Publication
(10) Pub. No.: US 2007/0276719 A1
(43) Pub. Date: Nov. 29, 2007

(54) User Interface in Automated Scheduling System

(75) Inventor: Bruce Franco, Cambridge, MA (US)

Correspondence Address: MILLS & ONELLO LLP, ELEVEN BEACON STREET, SUITE 605, BOSTON, MA, 02108, US

(73) Assignee: MIX&MEET, INC., Cambridge, MA (US)

(21) Appl. No.: 11/754,054

(22) Filed: May 25, 2007

Related U.S. Application Data
(60) Provisional application No. 60/803,251, filed on May 26, 2006.

(51) Int. Cl. G06F 15/02

(52) U.S. Cl. 705/9

(57) ABSTRACT

Provided is a method of providing an interactive user interface to an automated meeting system. The method comprises storing meeting data including user identifications representing a set of users associated with a meeting and generating for presentation via a user device at least a portion of the meeting data, including one or more of the user identifications. And the method includes generating for presentation via the user device one or more communication mechanisms configured to enable double-blind communication with at least one user corresponding to at least one of the user identifications, wherein the one or more communication mechanisms includes mechanisms configured to generate a semi-formatted message, from a set of selectable semi-formatted messages, for transmission to the at least one user.

### CROSS REFERENCE TO RELATED APPLICATION

This application claims the benefit of priority under 35 U.S.C. §119(e) from co-pending, commonly owned U.S. provisional patent application Ser. No. 60/803,251, entitled SYSTEM AND METHOD FOR SCHEDULING MEETINGS, filed May 26, 2006, which is incorporated herein by reference in its entirety.

### TECHNICAL FIELD

This disclosure relates to systems and method used for scheduling meetings and, more particularly, to on-line systems and methods for scheduling meetings without extensive user time and effort.

### BACKGROUND

With the evolution of the Internet, personal communications and information sharing has been expanded to unprecedented levels. Additionally, Internet-based applications have evolved from traditional industries to exploit the vast connectivity provided by the Internet. For example, several Internet-based services now exist that provide some form of “social networking.” Traditional social networking sites are generally account-based websites that facilitate meetings through mutual affirmation, negotiation, or “opt-in,” approaches. That is, the parties must each assent to the meeting beforehand and then arrange a meeting at some later point in time. Therefore, this requires some interaction among the meeting members prior to assenting to the meeting and prior to, or as a means for, those individuals scheduling a meeting. In other words, such services and Web sites are not truly real-time, since there is a variety of user activity that must take place before a meeting be can scheduled and take place.

Although not exclusively, a common form of social clustering services are on-line dating or matchmaking websites. Generally, these are merely semi-automated approaches to what had been done before. In their most common forms, on-line dating requires paid membership, wherein each member stores a profile of personal information (or “wish list”) via the website. These profiles are intended to be used to increase the likelihood of a compatible match, or at least a mutually satisfactory meeting (i.e., date). On-line dating services use various algorithms and methodologies to potentially match people, as at least a partial function of the profiles. Age, common interests, and other types of parameters can form part of such profiles and, thus, can be used to identify potential matches in a general geographic region, although without explicit attention to geographical specifics. A user provided profile can include data associated with these parameters and can be created when the user registers with the on-line dating service.

Often, the creation of a user profile can require considerable amount of time and effort from the user. For some on-line dating services, uploading a picture of the user can be requested for inclusion in their personal profile. Additionally, creation of a personal profile can include the user answering an extensive list of survey questions to characterize the user. Once the profile is completed, the profile data is used to identify a group of potential matches and this group is provided to the user. Reviewing the group, the user can decide to contact one or more of the potential matches to explore the possibility of dating and establishing a relationship. As can be expected, a considerable amount of user time is needed: from generating a profile, reviewing potential matches, and interacting with one or more potential matches to plan and schedule a date, and finally to meet one of the potential matches. Such dating sites include Date.com, Match.com, Matchmaker.com, PerfectMatch.com, Great-Expectations, eHarmony and Personals.Yahoo.com, to name a few.

Other forms of social networking might not have the end goal of dating, but can be similar in that they can also require a considerable amount of user time for scheduling social meetings. For instance, scheduling meetings for business networking or meetings for people that have a common interest (e.g., same type of job, hobby, sports fan, etc.) can take days—and require a considerable amount of user interaction with the scheduling system. These can first require the collection of user information from potential attendees, gauging of interest, and coordinating the meeting based thereon. Furthermore, scheduling complexity increases for social meetings in which attendees are traveling from different geographic locations—and such systems typically give no consideration to the location of the possible meeting members. Again, semi-automation is used to improve the efficiency of prior processes, but there is nothing particularly new about such services or systems. In fact, at some level, such systems and methods are inherently inefficient and limited, and certainly do not enable real-time meetings. These often presume the user will find a way to attend the meeting, since they do not take user location into consideration.

Yet another popular social networking site is Myspace.com, which has gained huge popularity and is not geared toward dating. Rather, this site provides a forum for individuals to interact over the Internet. Such sites allow individuals to make and interact with new friends, as well as existing friends. Such sites do not, however, provide mechanisms for arranging meetings and, in fact, the users can be so geographically dispersed that meetings could be impractical in the majority of instances. In any event, such system do nothing more than provide a forum of user interaction, not meeting scheduling. Rather, with these types of sites, the meeting really is online, rather than in person.

So called “flash mobs” can be construed as a form of social networking. Flash mobs typically are prearranged meetings of large numbers of individuals. For example, such meetings can be the result of one or more blast e-mails or cell phone text messages to individuals at a set of known addresses or phone numbers. The goal is to get as many people as possible to show up at the same place at the same time, e.g., at a political rally, protest, or the like. This is typically accomplished by a succession of messages, where each recipient invites people he or she knows, and then those recipients invite people they know and so on. Thus, the invitees and their addresses or phone numbers are known beforehand, by at least one person in the chain of messages.

While each of the above types of approaches and websites provide some utility in their selected areas of social networking, their focuses are relatively narrow. There is no true real-time networking ability and they tend to rely on a certain level of a priori knowledge about the invitees beforehand. Additionally, a significant amount of user interaction with a system and/or with each other is required.

### SUMMARY OF THE DISCLOSURE

In accordance with one aspect of the invention, provided is a method of providing an interactive user interface to an automated meeting system. The method comprises storing meeting data including user identifications representing a set of users associated with a meeting and generating for presentation via a user device at least a portion of the meeting data, including one or more of the user identifications. And the method includes generating for presentation via the user device one or more communication mechanisms configured to enable double-blind communication with at least one user corresponding to at least one of the user identifications, wherein the one or more communication mechanisms includes mechanisms configured to generate a semi-formatted message, from a set of selectable semi-formatted messages, for transmission to the at least one user.

The method can include generating for presentation via the user device a blocking mechanism configured to enable the user to identify one or more of the set of users from which communications are to be prevented.

The double-blind communication can include one or more of an e-mail, an instant message, a Web posting, a voice call, and a voice mail.

The semi-formatted message cab be a preformatted invitation to a subsequent meeting.

The semi-formatted message can include editable text.

The semi-formatted message can include a reference to the meeting.

The communication can include an image of the user sending the communication.

Each of the one or more user identifications can include an image of a corresponding user.

The method can further include generating for presentation meeting data including meeting history information of a user, the meeting history data including, for each meeting attended by the user, user identifications of other users that also attended each meeting.

The user identifications can be provided as selectable icons, and the method can include generating for presentation options for selecting the semi-formatted message addressed to an intended recipient, from the set of semi-formatted messages, in response to the user selecting an icon representing the intended recipient from the selectable icons.

In accordance with another aspect of the present invention, provided is an interactive user interface system configured to generate automated meeting scheduling outputs. The system comprises one or more data storage devices coupled to one or more computer processors that are accessible via a network. A computer program product is stored in the one or more storage devices and configured to be executed by the one or more computer processors to perform a method. The method comprises: storing meeting data including user identifications representing a set of users associated with a meeting; generating for presentation via a user device at least a portion of the meeting data, including one or more of the user identifications; and generating for presentation via the user device one or more communication mechanisms configured to enable double-blind communication with at least one user corresponding to at least one of the user identifications, wherein the one or more communication mechanisms includes mechanisms configured to generate a semi-formatted message, from a set of selectable semi-formatted messages, for transmission to the at least one user.

The method executed by the system can further comprise generating for presentation via the user device a blocking mechanism configured to enable the user to identify one or more of the set of users from which communications are to be prevented.

The double-blind communication can include one or more of an e-mail, an instant message, a Web posting, a voice call, and a voice mail.

The semi-formatted messages can be a preformatted invitation to a subsequent meeting.

The semi-formatted message can include editable text.

The semi-formatted message can include a reference to the meeting.

The communication can include an image of the user sending the communication.

Each of the one or more user identifications can include an image of a corresponding user.

The method executed by the system can further comprise generating for presentation meeting data including meeting history information of a user, the meeting history data including, for each meeting attended by the user, user identifications of other users that also attended each meeting.

The user identifications can be provided as selectable icons, and the method can include generating for presentation options for selecting the semi-formatted message addressed to an intended recipient, from the set of semi-formatted messages, in response to the user selecting an icon representing the intended recipient from the selectable icons.

Additional advantages and aspects of the present disclosure will become readily apparent to those skilled in the art from the following detailed description, wherein embodiments of the present invention are shown and described, simply by way of illustration of the best mode contemplated for practicing the present invention. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

FIG. 1 is a block diagram of users and locations that could be used for planning meetings.

FIG. 2A is a block diagram of a network of devices that could be used by the users of FIG. 1 for accessing a clustering system for planning meetings.

FIG. 2B is a block diagram of a possible embodiment of the clustering system of FIG. 2A.

FIG. 2C is a diagram illustrating some of the types of meetings that could be planned using the clustering system of FIG. 2B.

FIG. 3 is a flow chart that represents some operations of the clustering system of FIG. 2B.

FIGS. 4, 5 and 6 are representations of graphical user interfaces that can be presented on at least some of the digital devices shown in FIG. 2A, in response to communications by the clustering system of FIG. 2B.

FIG. 7 provides an embodiment of a meeting confirmation that can be generated by the clustering system of FIG. 2B.

FIGS. 8A and 8B provide an embodiment of communication screens that can be used to enable a user to communicate with a user that also attended a prior meeting.

FIG. 9 is an embodiment of a invitation screen that enables a user to invite other users to a meeting.

FIG. 10 is a flowchart depicting an embodiment of a clustering method in accordance with the present disclosure.

### DETAILED DESCRIPTION OF THE EMBODIMENTS

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In accordance with aspects of the present invention, provided is a network-based social clustering system and method that do not require any user-to-user interaction to schedule or arrange physical meetings between people already known to each other, people previously unknown to each other, or a combination thereof. People that know each other could be families, classmates, club members, teammates, co-workers, group members, church members, and so on. The clustering system is configured to schedule one or more meetings between two or more users at a mutually accessible public or private location based on a common denominator (or meeting purpose) and the geographic locations or areas of those users, as well as the geographic location of the meeting place. The system is not inherently limited to the number or types of meetings that can be scheduled.

The concept of a meeting purpose can be broadly interpreted. At a high level, a meeting purpose can be a social, business, political, professional, financial, educational, cultural, spiritual, charitable, recreational, therapeutic, or athletic purpose—as examples. In more specific examples, a meeting purpose can include at least one of a date, a singles gathering, a friends gathering, a business meeting, a special event gathering, a social gathering, an event-oriented social gathering, a sports participation event, a sport viewing event, a political meeting or rally, a religious gathering, or a gathering of people sharing a hobby or an interest. Again, these are representative examples.

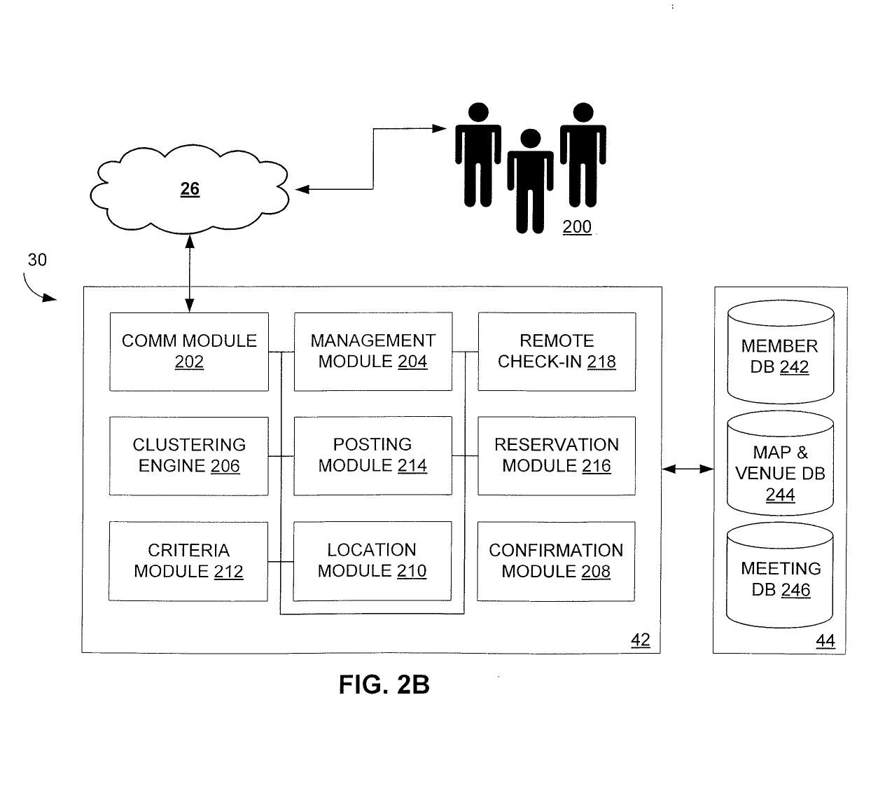

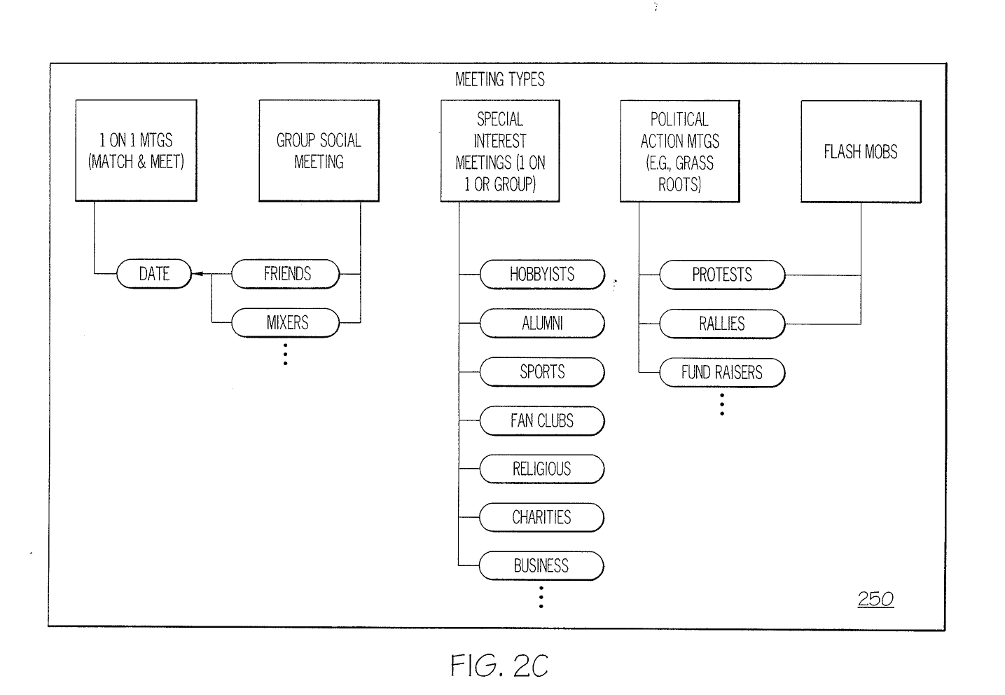

Any type of location or venue can be selected as a meeting location, for example, restaurants, parks, ball fields, street intersections, or other locations can be meeting locations represented with geographic coordinates or a street address, as examples. As specific examples, a meeting and meeting location could be a singles night at a bar, a golf outing at a country club, a business networking meeting at conference, a gathering of art enthusiast at a museum, a pick-up volleyball game at a beach, or a ski outing on a mountain. Other specific meeting examples include a gathering of two people on a blind date at a restaurant, a university's alumni in the same city at a nightclub, sports enthusiasts at a sports bar to watch the Super Bowl, hikers at a trailhead, a flash mob for a political rally at a landmark, or a family reunion at private residence. Motorcycle or car rally groups, cyclists, or runners could use the clustering system and method for arranging a meeting in a specific GPS location on or off road. A group of parents and children meeting at a playground and a group of people in a carpool meeting in a parking lot are other examples of specific meetings. In a carpool scenario, a destination location can also be determined for each user as a meeting constraint. And users could be clustered twice, around their starting locations and around their destination locations. Non-limiting examples of types of clustering meetings are provided in FIG. 2C, as discussed hereinafter.

A user can provide an input to the clustering system that expresses a desire to participate in a meeting having an identified meeting purpose, and may include (or be used to determine) additional meeting constraints, user information, or both. The input can include a set of entries provided by the user during a session, e.g., Web session, IVR session, e-mail session, or the like. The user's input to the clustering system, which can take the form of a reservation, is preferably the only meeting specific input required by the user in the preferred embodiment. Using that input, a meeting can be scheduled that includes the user. The meeting could be scheduled in real-time and for the same day or for a future date. In some situations, a user can be added to a meeting that has already begun, e.g., if a meeting having a purpose consistent with the user's purpose is in-progress in the user's geographic area.

A meeting can be scheduled around a posted meeting purpose, which can be posted by a user or the system. The user's input can be a posting of a meeting purpose to the clustering system to initiate the scheduling of a meeting. Otherwise, the user's reservation can be an input that indicates a desire to participate in a meeting already posted. Meetings are formed and scheduled by clustering users interested in a meeting having the corresponding meeting purposes and in the same geographic area—referred to as geographic clustering. After the single reservation input by the user, the next communication received by the user is typically a meeting confirmation indicating the meeting location and time. No negotiation among the users is required. The confirmation can include directions to the meeting location, the meeting time, and identifications of the other meeting participants.

The clustering system can also be configured to make a reservation at the meeting location, for the meeting time and the corresponding number of users (i.e., participants). And the clustering system can optionally enable remote check-in by the users, e.g., near meeting start time or during the meeting. Meetings can be scheduled where the clustered users (as meeting participants) self-assemble at a meeting location—without any receptionist, host, supervisor, or sponsor. In other embodiments, the meeting format could be structured to include those elements as well.

In the preferred embodiments, the geographic clustering is used to determine two or more users from a plurality of users in the same geographic area that have the corresponding meeting purposes. The determination of the users is, therefore, based on the locations of the two or more users. The input of each user can include or be used to determine a user location used to perform the geographic clustering. A user location could be represented by or derived from one or more of a latitude and a longitude, an altitude, a zip code, a street address, an intersection, a transportation stop, an area code, a telephone exchange, a mapped location, a venue, a landmark, a cell of a cell phone network, GPS coordinates, or a wireless fidelity (WiFi) cell. For example, a user location can be a park, a hiking trail, a mountain, a lake or a river, a city, town, county or state, a building (e.g., public, private, or government), a subway stop, or a tourist attraction. As examples, a building could be a stadium, a hotel, a restaurant, a museum, a concert hall, a theater, a tavern, a residence, a train station, or airport.

Beyond geographic clustering, users can optionally be further selected for a meeting using various types of personal information. Such personal information can have been input by the user, gleaned from past information submitted by the user (or learned about the user), or a combination thereof. For example, the personal information, such as interests, background, traits and other characteristics, can be analyzed among potential meeting participants to determine an actual or potential match for a meeting.

As described in greater detail below, the clustering system is a network accessible system that can be configured to be accessed via any known or hereafter developed type of networks and by any known or hereafter developed types of network enabled devices, whether wired, wireless or some combination thereof.

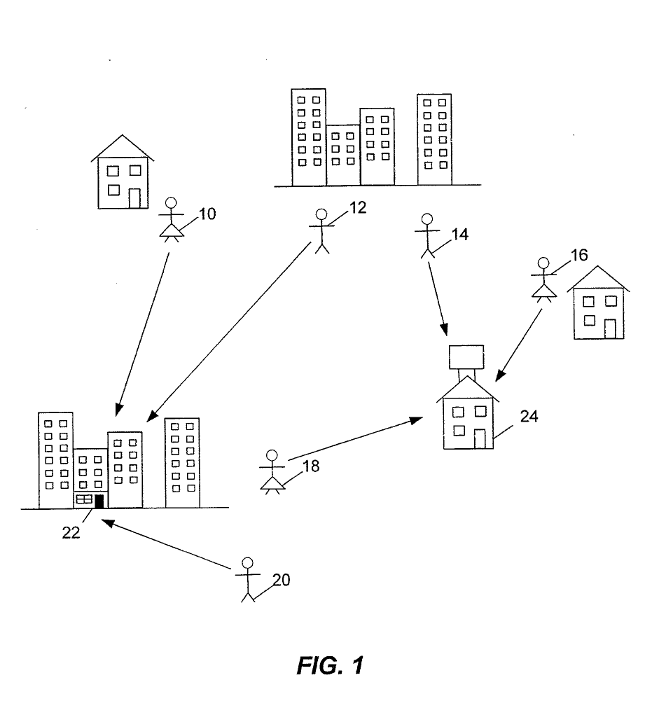

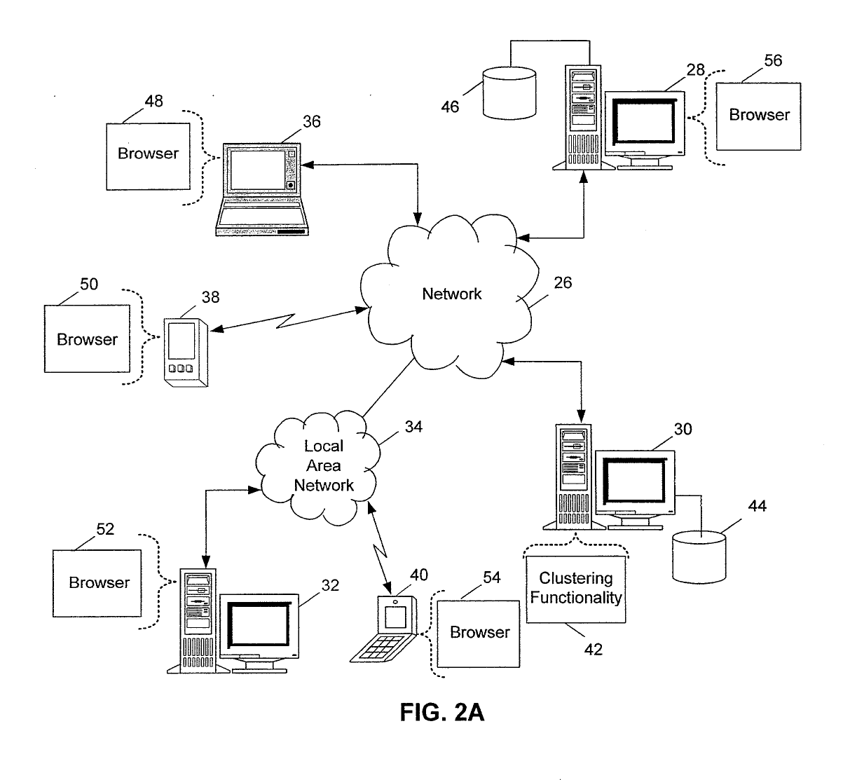

Referring to the illustrative representation of FIG. 1, various people 10, 12, 14, 16, 18, and 20 are interested in attending a clustering meeting. These people can access a clustering system (see, for example FIG. 2A and FIG. 2B), in accordance with this disclosure, to find or have scheduled a meeting. Users can be clustered according to a shared meeting purpose and user locations. In this example, suppose that persons 10, 12, and 20 are interested in attending a business networking meeting, as a meeting purpose, while persons 14, 16, and 18 are interested in attending a singles gathering, as another meeting purpose. Based on the shared meeting purposes of the users, the clustering system provides the service of scheduling an appropriate number of meetings and determines an appropriate location for each meeting. For example, based on the location of persons 10, 12, and 20, the clustering system selects an urban location 22 for the business networking meeting. Similarly, based on locations of persons 14, 16, and 18, the clustering system 30 selects a rural location 24 for the singles gathering.

Accordingly, each of locations 22 and 24 can be respectively selected using geographic clustering based on physical or geographic considerations associated with the users, such as user locations. Additionally, the locations can be selected to minimize travel distance for at least one of the users/ meeting participants. In some embodiments, users can be associated with classes. In such cases, the clustering system 30 can be configured to minimize travel distances for at least one of the classes. In some embodiments, the clustering system 30 prioritizes the users or classes of users and minimizes travel distances based on the prioritization.

Other constraints that can be used to schedule a meeting can be the size or composition of the meeting and its participants. For example, a specific number of users or a numerical range of users can serve as a parameter for clustering users to form a meeting. In one example, a singles gathering can be constrained for a particular female-to-male attendee ratio or a particular number of male and female attendees, e.g., in one embodiment 2-to-1 female-to-male ratio, or in another embodiment 6 females and 4 males. A political rally can be constrained to democrats, republicans, or independents, or perhaps members of special interest groups, as another example, whereas a flash mob can be unconstrained.

In various embodiments, combinations of constraints can be used to plan and schedule a clustering meeting. For example, along with constraining a meeting for a particular female-to-male attendee ratio, a meeting location can be selected that minimizes the travel distance for female attendees, without giving such consideration to the male attendees. To accomplish this, the clustering system can weight the locations of the female attendees more favorably than it does the male attendees, as one possible manner of prioritizing females over males. The examples of considerations and constraints given herein are not intended to be an exhaustive or limiting list—merely representative examples.

Meeting constraints can be automatically adjusted if they cannot be satisfied. For example, if the constraints for a social meeting were with eight females and six males, but a sufficient number of users could not be determined in the geographic area, the constraints could step down to six females and four males. In another example, the meeting constraint could be ten people with a 50/50 male-to-female ratio. If enough users were not available, that could be stepped down to eight people 50/50 ratio, six people 50/50 ratio, etc. One constraint could be adjusted to nine people with a 5/4 ratio, and so on.

Referring to FIG. 2A, a network 26 allows a vast array of network-enabled devices to share information and data by transmitting and/or receiving electronic communications. For example, such devices can include personal computers (including laptop computers), telephones (including cell phones), personal digital assistant (PDAs), interactive cable or satellite televisions Internet-enabled device, and other network enables devices.

Network 26 can be implemented with various types and combinations of technology and include any type of standalone or combined wired or wireless networks. Such networks can include the Internet, World Wide Web, wide area networks (WANs), local area networks (LANs), virtual private networks (VPNs), satellite networks, cable television networks, cell phone networks, and plain old telephone service networks, or a combination thereof. For example, network 26 can include a LAN for a college campus or a WAN for business entity. Network 26 preferably enables communication of information and data using the Global Positioning System (GPS) for determination of locations of users operating GPS enabled devices and, optionally, providing directions.

In this exemplary arrangement, computer systems 28 and 30 are directly connected to network 26 and a computer 32 is connected to network 26 via a LAN 34. A laptop computer 36 is connected to network 26 by a hardwire (e.g., cable, telephone system, etc.) and a personal digital assistant (PDA) 38 is connected to the network 26 by a wireless link (e.g., radio frequency (RF) link, infrared (IR) link, etc.). A cellular telephone 40 is also connected by a wireless link to LAN 34. These are merely representative examples.

In this embodiment, computer system 30 is a network accessible system that hosts a set of clustering system functionality 42—such that system 30 can be referred to as a clustering system 30. In various embodiments, the clustering system functionality 42 can be embodied in hardware, firmware or software, or a combination thereof. To the extent embodied in software, the functionality can be stored in at least one storage device 44 (e.g. a hard-drive, Read/Write CD-ROM, etc.) and configured for execution by the one or more processors (not shown). These processors and data storage devices can be collocated, remote to each other, or some combination thereof. In this particular arrangement, clustering system 30 is depicted as a central computer system, however, in other arrangements it can be distributed among two or more computer systems, collocated or remote to each other.

The users shown in FIG. 1 can interact with clustering system 30 via network 26 using any of the above noted user devices 28, 32, 36, 38, and 40, as examples, to receive such services. Each of these devices can be configured with a typical browser, for browser-based interaction with clustering system 30, such as Microsoft Internet Explorer™ or Netscape Navigator™. In FIG. 2A, computer systems 28 and 32, laptop computer 36, PDA 38, and cellular telephone 40 execute respective browsers 48, 50, 52, 54, and 56. Along with enabling each user to provide inputs (e.g., reservations) to clustering system 30, browsers 48-56 also present clustering meeting information to the users (e.g., confirmations).

A user can submit (or input) a reservation through a single communication with clustering system 30, e.g., through a browser, interactive voice response (IVR), or test message interface. The reservation can be a posting that requests a meeting having a certain meeting purpose (e.g., singles gathering) or an input that indicates a desire to participate in a meeting posted by another user or by clustering system 30.

After clustering system 30 schedules a meeting, a confirmation that includes meeting information can be sent via network 26 to each user via its user device (e.g., computer 28) and rendered via an appropriate browser (e.g., browser 56). The confirmation can include a meeting location and time. The confirmation can also include directions to the meeting location. And the confirmation can include an identification of users clustered to attend the meeting, e.g., a name of each user, an image of each user, or both. For example, with reference to the example of FIG. 1, if users 10, 12 and 20 were clustered to meet at location 22, user 10 could receive a confirmation identifying the meeting location 22 and users 12 and 30.

FIG. 2B provides one possible functional block diagram embodiment of the clustering system 30 and clustering system functionality 42 of FIG. 2A. Generally, a user can access clustering system 30 and submit or input a meeting reservation indicating a meeting purpose and a user location. In response to the reservation, the clustering system 30 can schedule a new clustering meeting, or add the user to a scheduled future meeting or a meeting in-progress. This can all be done in real-time (or near real-time) and the meeting can be a same day meeting. For example, the user's reservation could indicate that the user wants to go out that night to meet other singles in the city of Boston. With no other input from the user, the clustering system 30 can schedule a meeting and send the user a confirmation. No communication or negotiation among the users is required to schedule a meeting, nor is any negotiation between a user and the clustering system 30 required to schedule a meeting.

The user's reservation can include a posting for a new meeting or express a desire to participate in a posted meeting, or the system can do the posting. For example, clustering system 30 could post a meeting indicating that there will be a singles gathering on Friday night at 8 pm in the Boston area. The user's reservation could indicate a desire to participate in that singles gathering. Or, if there is not a meeting posted that the user desires to attend, the user's reservation could include a posting for a new meeting, e.g., a gathering of James Bond movie fans at a premiere of a new James Bond movie. For system posted meetings, or user posted and system processed meetings, the clustering system can send out an electronic broadcast message indicating the posted meeting; and the user's response to the broadcast message can be the user's input (or reservation). For example, the clustering system could broadcast a text message and the user's reply/ send to the message can be the user's input, with the user's location determined in accordance with the various possibilities noted in this disclosure.

The clustering system 30 can determine whether other users, from a plurality of users, in the same geographic area have submitted reservations with a corresponding meeting purpose. This determination can be made at the time the user makes the posting, or thereafter. In either case, once a group of users in the geographic area having corresponding meeting purposes are determined, the meeting is scheduled and confirmations can be sent to the users.

In FIG. 2B, the users (e.g., users 10, 12, 14, 16, 18, and 20 from FIG. 1) and their respective user devices (e.g., devices 28, 30, 32, 36, 38, and 40 from FIG. 2B) are collectively represented as users 200. In this embodiment, storage device 44 from FIG. 2A is shown to include databases 242, 244, and 246. Member database 242 can store various types of information for users of clustering system 30; each member could have a user account on clustering system 30. Third party systems and data sources (not shown) can also be accessed, for example to obtain location or venue information, map information, transportation information, and the like, which can be stored in map and venue database 244. A meeting database 246 can be used to store information of past, present, and future meetings, including meeting locations, times, and participants.

In this embodiment, clustering system functionality 42 includes a set of modules that enable clustering system 30 to provide the clustering services and functions described above. For example, such modules can include a communications module 202 configured to process received messages and to prepare messages for transmission. Accordingly, communications module 202 is configured to transmit and receive messages via any of the above-mentioned networks and devices, so can include, for example, one or more of Web hosting functionality, e-mail functionality, IVR functionality, and text messaging functionality. In the illustrative embodiment, communications module 202 is comprised of known functionality, so is not discussed in detail.

A management module 204 can be included to provide overall management of the clustering system functionality 42, such as tasking other modules, session management, account management, data management, and so on. For example, the clustering system 30 can be configured to establish accounts for its various users. If so, such users become “members” and personal information and data relative to each member can be stored in an account in member database 242, which can comprise part of storage device 44 of FIG. 2A. Member information can include one or more of a user identification, contact information, personal information, professional information, clustering meeting history, biographical information, demographic information, and so on. As specific examples, the member information can include a user's name, a username or alias, a password, a user's address (home, business or both), phone number, e-mail address, age, gender, sexual preference, race, religion, profession, income, interests, special interest groups or categories, affiliations, image, video, audio, and so on. The actual determination of which of the foregoing are stored can differ in different embodiments.

In various embodiments, members can be required to pay membership fees, per meeting fees, or both—or perhaps other forms of fees. In other embodiments, the services provided by clustering system 30 can be free to the users, but user accounts can still be kept. In any of the various user payment embodiments, payment information or financial account information can also be stored in member database 242. Such information could include payment history, invoice information, electronic fund transfer information, credit card information or the like. In such cases, management module 204 includes the functionality necessary to establish, edit, and terminate user accounts, and to create, edit, and delete any other information, data, and the like.

A meeting can be scheduled based on a posted meeting purpose, which can be accomplished using a posting module 214. The meeting purpose can be posted by the clustering system 30, e.g., by management module 204. In other cases, the user's reservation can include a posting for a new meeting or express a desire to participate in a posted meeting.

Once a reservation for a meeting has been received via the communication module 202, the management module 204 tasks a geographic clustering engine 206 to cluster a set of users from a plurality of users to schedule a meeting. The clustering engine 206 determines the user's location from the reservation. The location can be determined in any of a manner of ways, which can include determining the user location from one or more of a zip code, an area code, a cell of a cell phone network, GPS coordinates, a landmark, an address, a phone exchange, a latitude and a longitude, an altitude, a street intersection, a named location, and a wireless fidelity (WiFi) cell. The location can be explicitly input as part of the reservation, which could include selection of a geographic location via a Web site or IVR system. In some embodiments, an identification of the user can be determined from the reservation, and the clustering engine 206 can determine the user location from information associated with the user's member account stored in member database 242, e.g., an address, zip code, or telephone exchange. The member account information could serve to indicate a default user location, as well as other default information used by clustering engine 206 to cluster users (e.g., age, gender, preferences, interests, etc.). The clustering engine 206 determines a subset of users from a plurality of users that have corresponding meeting purposes and are within the same geographic area, based on their user locations.

Geographic clustering engine 206 can include or interface with a criteria module 212 to perform the geographic clustering according a set of meeting criteria or constraints. The meeting constraints can include a meeting purpose and time and a geographic area. In some embodiments, the criteria module 212 can also be used to define secondary meeting criteria or constraints, such as a number and type of attendees used in selecting users for the meeting. For example, if the meeting purpose is a singles gathering in the Boston area, the criteria module 212 can be used to define a number of men and a number of women and age ranges of prospective attendees, a ratio of men and women, or a numerical range of men and women. In other words, the constraints could be that there must be 4-6 men and 6-8 women or ten users with a 50/50 ratio of men and women. The geographic clustering engine 206 can then determine a set of users that can be included in the meeting. If these constraints cannot be satisfied, the geographic clustering engine can automatically adjust the constraints until a meeting can be scheduled. For example, if the constraints was ten users with a 50/50 ratio, those constraints could be adjusted to eight users with a 50/50 ratio, ten users with a 60/40 ratio, or nine users with a 5/4 ratio—as examples. The criteria module 212 can, therefore, be used as a source of parameters or constraints used to cluster users. The clustering engine 206 can receive user information related to such constraints from member database 242, the user input (or reservation), or a combination thereof.

The reservation can also include a meeting date, for example, same day or a future date, as well as a meeting time or timeframe (e.g., next Friday at 8 pm, or tonight). The reservation can also specify other meeting constraints or preferences input by or otherwise associated with the user, such as the maximum distance the user is willing to travel to attend the meeting. The reservation can include or be used to determine other useful parameters or constraints associated with the user, e.g., the user is Asian, a single parent, Catholic, SiFi fan, and so on). These types of information can also be used by clustering engine 206 as further constraints or parameters used to select users for participation in a meeting. In some embodiments, the clustering engine 206 can determine such additional information from member database 242, e.g., based on an identification of the user from the user's reservation.

In the preferred embodiment, the geographic clustering engine clusters users by defining geographic areas around users to determine overlaps. This can be done within a larger geographic area, e.g., within an area indicated by a zip code, telephone exchange, metropolitan area—as examples. If a sufficient number of users cannot be clustered using the settings above, the geographic clustering engine 206 can adjust the settings to better cluster users, e.g., by expanding or contracting the ranges and/or redefining the larger geographic area. The above adjustments can be performed to meet minimum meeting constraints, to optimize the number of meetings that can be scheduled, or to enhance meeting location selection options.

Geographic clustering engine 206 can include or interface with a location module 210 configured to determine the meeting location based on the user locations of the selected users. In addition to the users' locations, the location module 210 can determine the location based on the meeting purpose, size, and distance considerations. The meeting location can be selected from a set of possible locations or venues in the geographic area of the users. Generally, the meeting location is determined to minimize travel distance for at least one of the users attending the meeting. In one embodiment, the travel distances of all users attending the meeting is minimized to the maximum extent possible, based on available meeting locations for the meeting. In other embodiments, users can be prioritized and travel distances can be minimized based on the prioritization, as discussed above with respect to FIG. 1. For example, women could have travel distances of not more than 10 miles and men could have travel distances of not more than 20 miles as additional meeting constraints.

In determining meeting location, the location of each user participating in the meeting can be used as a starting location for the respective user. The user location can be determined from any of a variety of information, as discussed in detail above. As examples, a starting location could the user's home address, business address, zip code, a telephone exchange, street intersection, landmark, the address of a hotel the user will be staying at on the date of the meeting, and so on. Any of these can be converted into GPS coordinates for distance determination and routing, as an example. If the user's device is GPS enabled, a current location could be determined from the GPS coordinates provided by the GPS enabled device and used as the starting location.

The location module 210 can determine distances using GPS coordinates—i.e., the distance of a line connecting two points within the coordinate system. The math used for such determinations is well known. Additionally, the location module 210 could access mapping systems and databases for determining distances or routes, whether in map and venue database 244 or provided by a third party. Database 244 could also include listings for possible meeting venues, e.g., restaurants, bars, night clubs, convention centers, and so on. But these could also be obtained from third party systems. Once the location (or venue) is chosen, the location module 210 can generate maps, directions or other travel related instructions for the users, which can be specific to each user based on the users' respective starting locations.

Clustering system 30 can also include or interface with a reservation module 216 for automatically making reservations at such venues, if required. For example, many restaurants have on-line reservations systems, tickets for events can be purchased using automated systems, and registration for functions, seminars, classes, tours, etc. can typically be done using automated computer systems—as a few examples.

Clustering system 30 also includes a confirmation module 208 configured to generate confirmations to be sent to each user selected for a meeting. A confirmation includes the meeting time and location, and can include information identifying one or more of the users selected to participate in the meeting. The confirmations are sent over network 26 to the appropriate users 200 using communications module 202. The confirmations can be generated to include information and data to be presented at the user device, e.g., laptop, PDA, or cell phone, and, for example, for display in any of a variety of known browsers, as appropriate. If directions were generated, the confirmation can include those. If there are certain expectations or requirements of the user, e.g., a dress code, required gear, and so on, the confirmation can include those as well.

Additionally, clustering system 30 can include or interface with a remote check-in module 218. The remote check-in module is configured to enable a user to check-in with other users regarding participation in a meeting. The communication is preferably double-blind, so each user's privacy is protected. As an example, if a meeting began at 8 pm and a user had not arrived by 8:30 pm, the user could check-in by sending a message (e.g., voice, e-mail, or text) to clustering system 30 that he was going to be an hour late. As another example, if a user was at a meeting, and had not yet found any other user, the user could send a text message indicating that she was at the location, and perhaps where she was standing. The remote check-in module 218 allows users to communicate regarding an already scheduled meeting, with some privacy. It also better enables such meetings to take place without a host.

Referring to FIG. 2C, a diagram is provided that shows various types of meetings that can be scheduled. For example, a “1 on 1” meeting can be a date, such as a blind date. A social group meeting, can be a gathering of friends, a gathering of singles (or “singles mixer”). Special interest meetings can be 1 on 1 or group meetings, and can include meetings for hobbyists, alumni, sports enthusiast or fans, fan clubs, religious individuals, charities, and business functions. Political meetings can include protests, rallies and fund raisers. Flash mobs could include protest, rallies, and so on. These are merely examples, and not meant to be limiting.

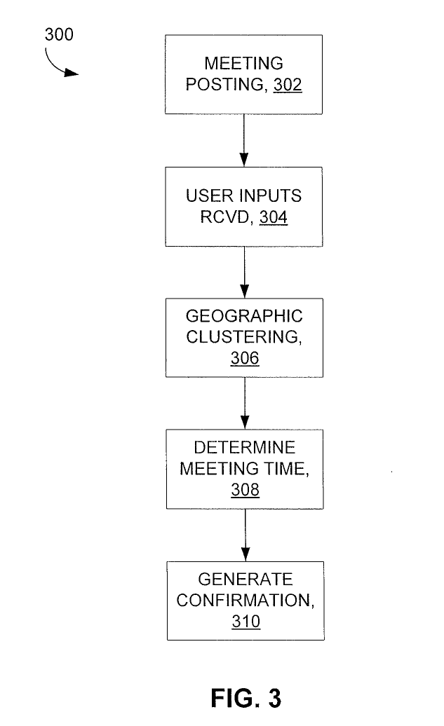

Referring to FIG. 3, shown is a flowchart 300 of a method for automatically clustering users for a meeting, which can be implemented by the clustering system 30 of FIGS. 2A and 2B. In step 302, there is a posting indicating a meeting having a meeting purpose is to be scheduled. The posting can be by a user or the clustering system 30. In step 304, clustering system 30 receives inputs from a plurality of users. Each input indicates a desire to attend a meeting of a particular meeting purpose and indicates a user location, or one can be determined from the user input. In step 306, geographic clustering is performed, which includes determining a subset of users in the geographic area, from the plurality of users, having expressed a meeting purpose corresponding to the posted meeting purpose. The geographic clustering also includes determining a meeting location based on the locations of the subset of users. In step 308, a meeting time is determined. And in step 310, a confirmation is generated to be sent to the subset of users indicating the meeting time and location. The method can also include making a reservation at the meeting location and providing remote check-in features to the subset of users.

In accordance with the above method, the clustering system 30 can be configured to schedule clustering meetings within a relatively short period of time, it can be in real-time. No communication among the subset of users is required to schedule a meeting, and preferably only one input is required by each user before receiving a meeting confirmation. If the user expressed an interest in immediately attending a meeting, the clustering system can be configured to add the user to an existing meeting. Otherwise, the user input can be used to schedule a new meeting.

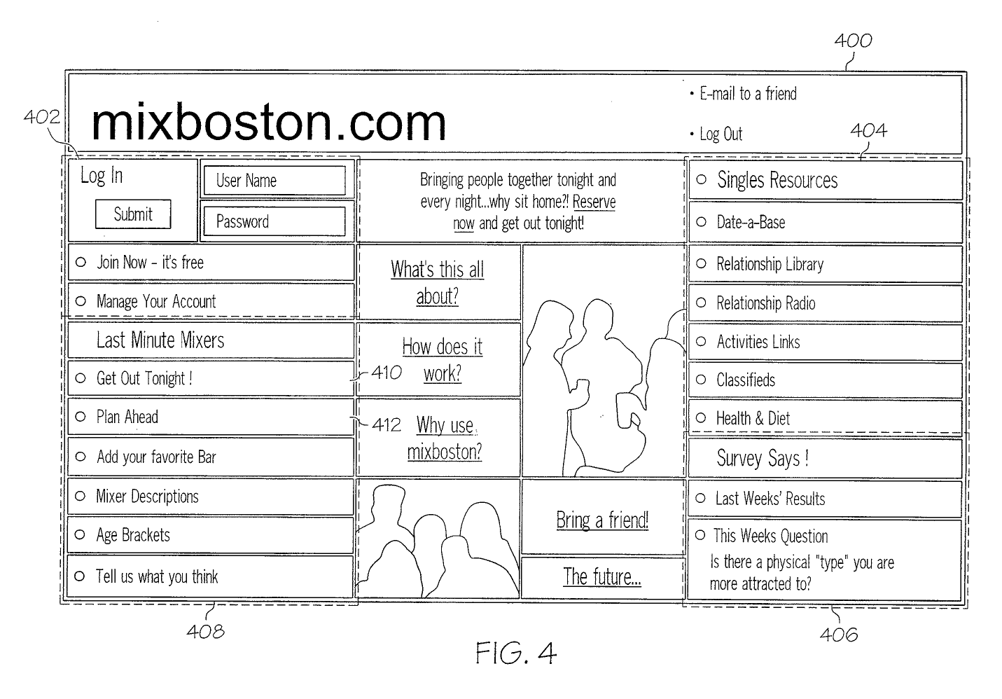

FIG. 4 is an exemplary graphical user interface (GUI) 400 that can be provided to users of the devices shown in FIG. 2A (e.g., computer system 28, PDA 38, cellular phone 40, etc.) for interacting with clustering system 30. For this application, GUI 400 is tailored for single people that can be interested in attending a singles social meeting, as an example. Typically, GUI 400 is presented through the respective browsers executed by each of the user devices. By using GUI 400, a user can be granted access to the functionality 42 of system 30, for example, to provide and/or store information associated with the user and to schedule meetings. For instances where the user device does not include such a browser (e.g., a phone without a display), such user devices interact with system 30 through other standard communication interfaces—system 30 is not limited to devices with browsers, as discussed above.

In the exemplary design of FIG. 4, GUI 400 is partitioned into portions that provide links to various services. For example, portion 402 of GUI 400, which is designated with a dashed-line box, provides account creation and management links. This portion of GUI 400 also includes data fields for accessing an account (e.g., user name, user password). A portion 404 includes links to various resources and potential points of interest (e.g., links to radio talk shows, links to singles activities, etc.) for a single person. Additionally, a portion 406 includes links for users to take part in a singles related survey (e.g., dating questions) and to view results from previous surveys.

A portion 408 of GUI 400 includes links for setting up and participating in clustering meetings. Since this example is geared toward single people, portion 408 is entitled “Last Minute Mixers.” In general, the clustering system and method of this embodiment are structured so that single people can request to be included in a meeting and be invited to the scheduled meeting within a relatively short period of time. For example, system 30 can receive an electronic request (e.g., an extensible markup language (XML) file) via GUI 400 and send a corresponding invitation (e.g., an email message, XML file, etc.) within a matter of seconds. A link 410 included in portion 408 allows a user to express an interest for a same day meeting.

In other situations, a user's input could indicate an interest in a meeting being held at a later date. To be included in such a later scheduled meeting, the user can select a link 412 that is also included in portion 408. Link 412 can present a graphical calendar for use in selecting the date that he or she is interested in attending a singles event. Other options are also included in portion 408. For example, a user can enter one or more locations (e.g., favorite bar) that can potentially be used as a meeting venue, as a user preference or constraint. User preferences or constraints are also accounted for with the links included in portion 408. For example, a user can select to attend a particular singles meeting that includes attendees within specific age groups. A user can be interested in selecting from one or more particular types of singles meetings or meetings with particular constraints applied. For example, non-alcoholic events, events with a particular number of attendees, events with a particular female-to-male attendee ratio, or other types of meeting constraints that can be selected via links provided within portion 408. While these constraints and selectable options are presented with regard to singles meetings, it is understood that other types of selections and constraints can be associated with this type of meeting or other types of meetings (e.g., business networking meetings, special interests meetings, etc.).

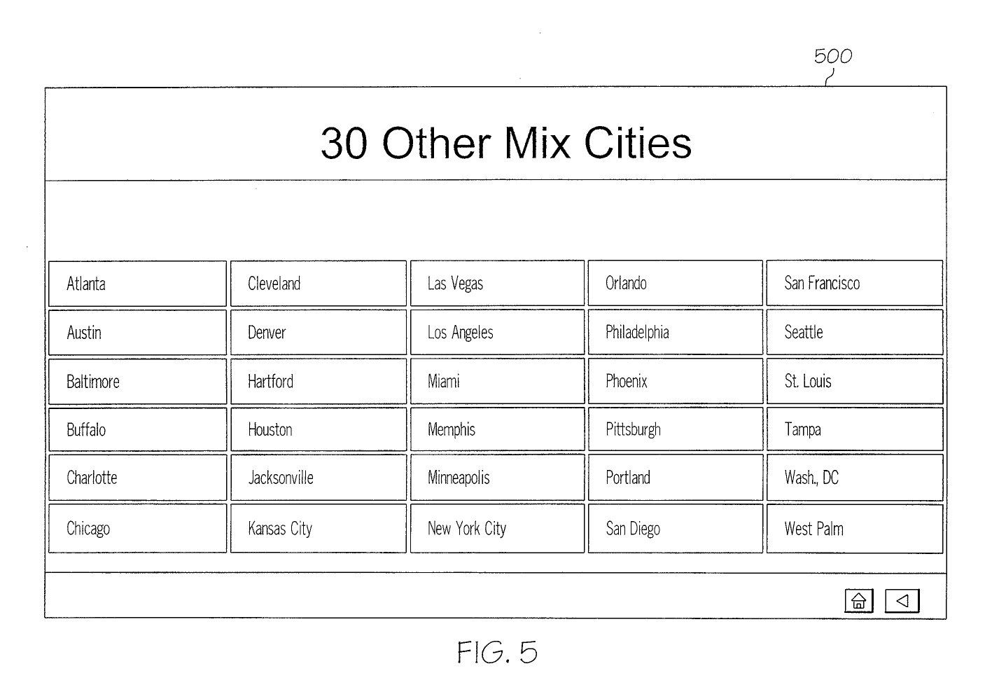

Referring to FIG. 5, in addition to selecting a particular type of meeting and potentially selecting a meeting that is constrained by one or more parameters (e.g., number of attendees, attendee age, etc.), a desired geographic location can also be selected by the user. In this illustrative example, a GUI 500 provides an interface for a user to select one or more desired locations to attend a meeting. Continuing with the example from FIG. 4, the user can select one or more cities in the United States in which he or she is interested in attending a singles meeting, as an example. By providing various selectable locations, the user can select the city where he or she resides, or a city that the user plans to visit. Thus, along with planning to attend a meeting in familiar surrounds, a traveler can plan to attend a meeting at a particular destination city. So instead of just spending time in a hotel or touring the city alone, a traveler can schedule to meet with one or a group of people that share similar interests. For example, the traveler can schedule to meet people with a similar background, interests (e.g., sporting teams, politics, causes, etc.), or other common demographic. By attending meetings with people having similar interests, the traveler can experience a collegial atmosphere in a new city and an enjoyable evening. Additionally, since clustering engine 206 preferably requires a relatively small amount of user interaction, a busy traveler does not need to expend a large amount of time and effort to participate in a meeting.

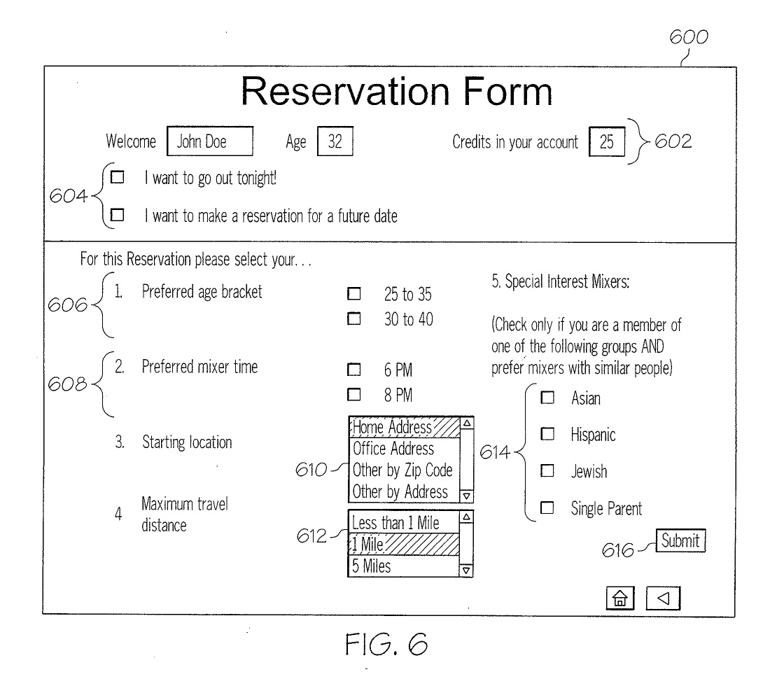

Referring to FIG. 6, a GUI 600 is presented as an exemplary interface for a user to provide an input for the purpose of attending a singles social meeting. GUI 600 includes numerous data fields for a user to input data that is relevant to planning a clustering meeting. However, the amount of requested input data is preferably constrained so that a user is not taxed for a considerable amount of time and effort. By reducing user interaction time, the probability increases that a busy user (e.g., a traveler) will continue through the entire process, rather than becoming frustrated with a seemingly endless list of questions and information requests as in prior systems.

In this illustrative example, GUI 600 includes a group of data fields 602 that identify the user (e.g., user name) and characteristics (e.g., user age) associated with the user. Additionally, the current state of the user's account (e.g., current number of account credits) is presented in data field group 602. In various embodiments, the concept of “credits” can be implemented. In such cases, the user can acquire (e.g., purchase) credits and “spend” them on planning and attending meetings. By presenting this information, system 30 can alert a user if an error has occurred during login or if the user needs to address a subscription issue (e.g., increase the amount of prepaid credits in his or her account).

GUI 602 also includes a set of two selector buttons 604 for the user to quickly identify when he or she would like to attend a clustering meeting. In this particular example, a user can choose to attend a meeting scheduled for that evening or to attend a meeting that is scheduled for a future date. If the user selects to attend at a future date, another GUI is presented so that a future date can be selected by the user.

Portions of GUI 600 facilitate the collection of user information that can be used for scheduling singles meetings (for this example) and/or for determining to which singles meeting(s) the user scheduled. In this example, GUI 600 includes a set of graphical buttons 606 that the user can select to suggest or require that the singles meeting be constrained to a preferred age group of attendees. Other types of constraints can be suggested and applied. For example, a group of buttons 608 can be included in GUI 600 so that the user can indicate the preferred time he or she would like to attend a clustering meeting. In this example, the user is given a choice of selecting to attend a meeting that starts at 6 PM or a meeting that starts at 8 PM. However, in some arrangements, GUI 600 can include a data field for the user to enter in a specific time or a suggested time that he or she would like to participate in a clustering meeting.

Location information can also be input via GUI 600 by the user. This location information can be used by clustering engine 206 for the geographic clustering. For example, a user starting location for attending a clustering meeting can be provided to location module 210. This location can be used to determine the travel distance of the user to a meeting. For example, by computing the travel distances to potential clustering meetings, system 30 can identify a clustering meeting that meets some or all of the user-provided constraints and also provides a shorter travel distance for the user. To collect a starting location from the user, GUI 600 can include a menu 610 that includes some previously entered and selectable addresses (e.g., home address, office address, etc.) associated with the user. Menu 610 can also include one or more fields to enable the user to enter other starting locations. In this example, menu 610 allows a zip code or an address to be entered by the user, as a couple of examples.

In addition to providing an address, the user can select how far he or she is willing to travel to attend a singles meeting. A menu 612 can be included with predefined, selectable maximum distances (e.g., radial distance) that the user can be willing to travel. In this example, maximum distances are provided in miles, however, in other arrangements, distances can be provided in kilometers or other measurement units. Menu 612 can additional, or alternatively, include one or more fields that enable the user to enter a maximum distance.

As mentioned above, various constraints can be provided by a user to potentially constrain scheduling of a clustering meeting. These can also be used to narrow the search of already scheduled meetings that the user can potentially attend. Furthermore, constraining parameters can be associated with the meeting attendees or the meeting itself. For example, the ratio of female-to-male attendees or male-to-female attendees can be selected by a user. The number of attendees can be constrained to a target size (e.g., ten attendees, one hundred, one thousand, etc.) or left unconstrained. In other embodiments, the system 30 could have predefined meeting types and sizes and the user could be added to one of those.

The other meeting characteristics can also be selected by the user. For example, a user can select to attend meetings that include live music, or events that are alcohol-free, or other types of meetings that are constrained by one or more parameters known to one in the art of singles event planning. In this particular event, GUI 600 includes a set of graphical check boxes 614 that can be individually selected by the user. Each of the graphical check boxes 614 allows the user to select a particular type of attendee to be invited to the meeting. In this arrangement, to request that the attendees be constrained to a particular group (e.g., Asian, Hispanic, Jewish, single parent, etc.), the user can be required to have identified itself as being a member of the selected group. In such cases, the system 30 can be configured to present for selection only those groups of which the user is a member. Alternatively, such a constraint need not be placed on the user making this selection. Once the user has entered the appropriate data and made the necessary selections, a submission button 616 can be selected by the user to send the entered data and these selections to clustering system 30 as a request for a meeting. The meeting is then planned and conducted as discussed with respect to FIG. 2B and FIG. 2C.

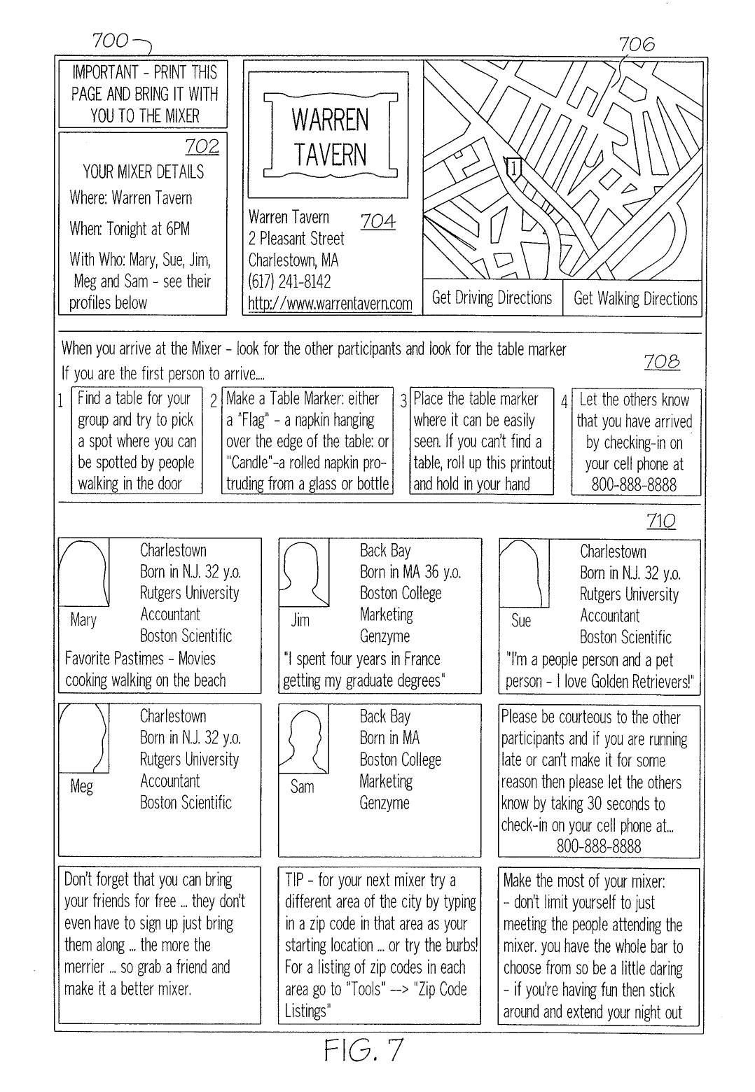

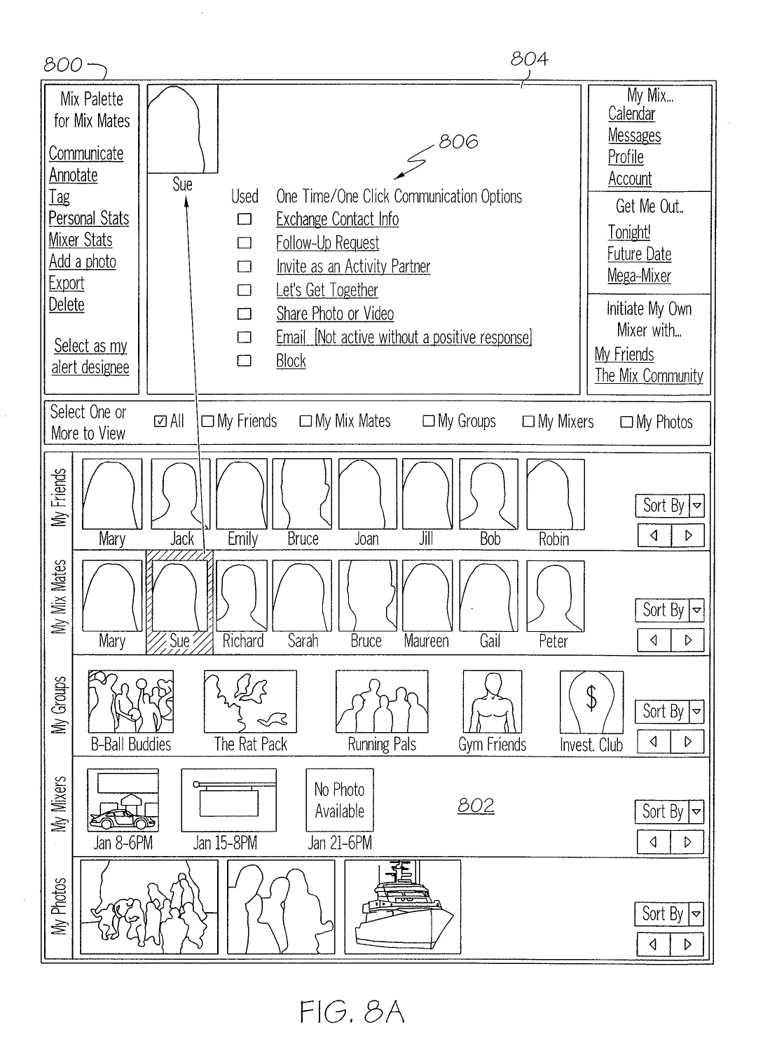

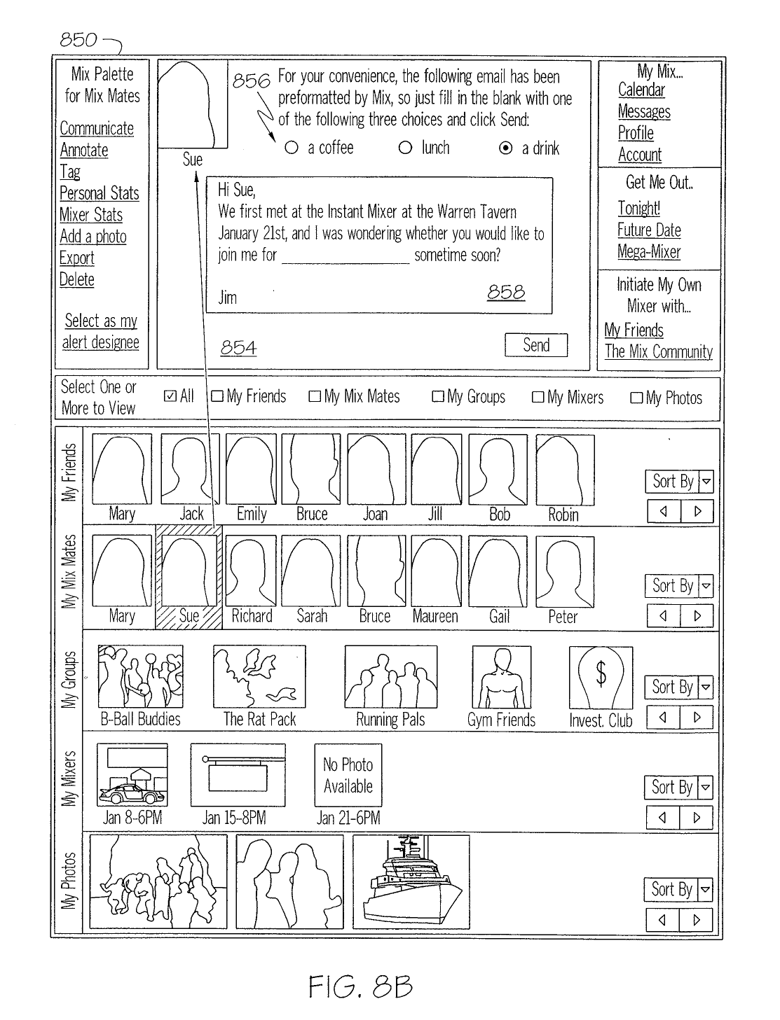

FIG. 7 provides an embodiment of a meeting confirmation 700 that can be generated by the confirmation module 208 of clustering system 30. The confirmation includes a details portion 702 that identifies the meeting location and time, along with the other users attending the meeting. Specific information about the venue is also provided in venue portion 704, and a map with options for directions is provided in map section 706. An instruction area 708 can be included that gives some guidance to the user relative to the meeting, for example instructions for placing a table maker to be quickly identified by other users. Also, in this embodiment there is a profile portion 710, which includes profiles of the other users, which can include images of the other users. The profiles enable easy identification at the meeting and give general information that could help “break the ice.”

FIG. 8A provides an embodiment of a communication screen 800 that can be used to enable a user to communicate with another user that also attended a prior meeting. In this embodiment, a user is logged into its account. Screen 800 includes an area 802 entitled “My Mix Mates” that indicates other users that have attended a meeting with the logged in user. In this example, Sue has been selected, and her picture appears in a message area 804. Also in message area 804 is a set of communication options 806 related to communications with Sue. In this case, the preformatted messages include Exchange Contact Info, Follow-up Request, Invite as an Activity Partner, Let's Get Together, Share Photo or Video, Email, and Block. The user can select among these options, which are largely self-explanatory. The Block option allows the user to block Sue from communicating with the logged-in user, as a preemptive measure. The Email option requires a “positive response.” That is Sue has to assent to the logged-in user getting her e-mail address. These features enable efficient messaging options for users, so significantly reduce user time.

FIG. 8B is an embodiment of a communication screen 850 that can be presented when the user selects the Let's Get Together option in FIG. 8A. The screen 850 is substantially similar to screen 800, except message area 804 has transitioned to semi-formatted message 854. Message 854 includes a set of options related to a type or purpose of the get together, e.g., coffee, lunch, or a drink. Area 858 includes semi-formatted text that can be edit and completed as need by the user. Those skilled in the are will appreciate that such screens could take other forms without departing from the scope of the present invention.

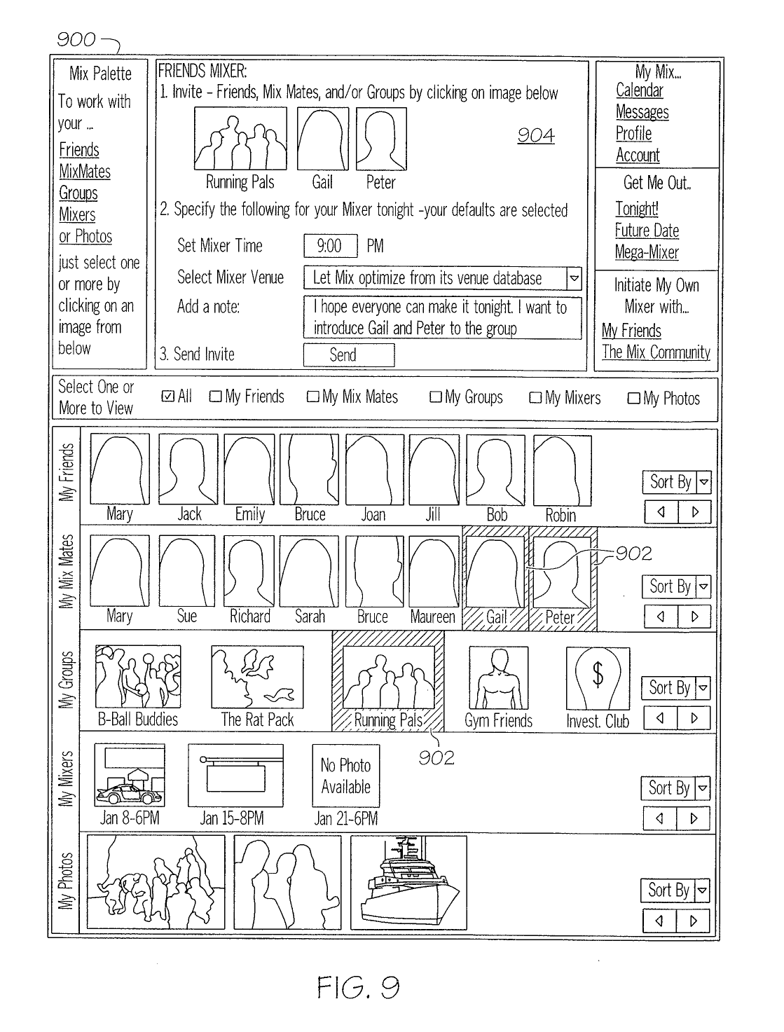

FIG. 9 is an embodiment of a invitation screen 900 that enables a user to invite other users to a meeting. In this embodiment, as with screens 800, and 850, various views are provided into information associated with the user, e.g., in the user's account. These views include My Friends, My Mix Mates, My Groups, My Mixers, and My Photos. The views My Friends, My Mix Mates and My Groups individuals or groups known to the user. Selection of icons in those views allows the user to communicate with the selected individual(s), group(s), or both. The invitation generation area 904 facilitates this form of such communication. In this screen, the user has selected his Running Pals group and the individuals Gail and Peter to be invited to a meeting. The invitation generation area 904 shows the invitees and also allows the user to specify a time for the meeting. An item labeled Select Mix Venue allows the user to specify a venue or to allow the clustering system 30 to determine the venue. Exemplary options can include: Poll the invitees using my favorites list; Let the clustering system optimize from its venue database; I will pick the venue from my favorites list; I will select the venue type & let the clustering system optimize; and Let the system optimize from its venue database. An area can also be included to enable the user to enter a free text message or note. Once the invitation is complete, the user can click “Send” to transmit it to all users. The communication can be double-blind with respect to one or more of the invites to protect their privacy. The default position can be that the communication is double-blind to all invites unless otherwise specified by the invitee.

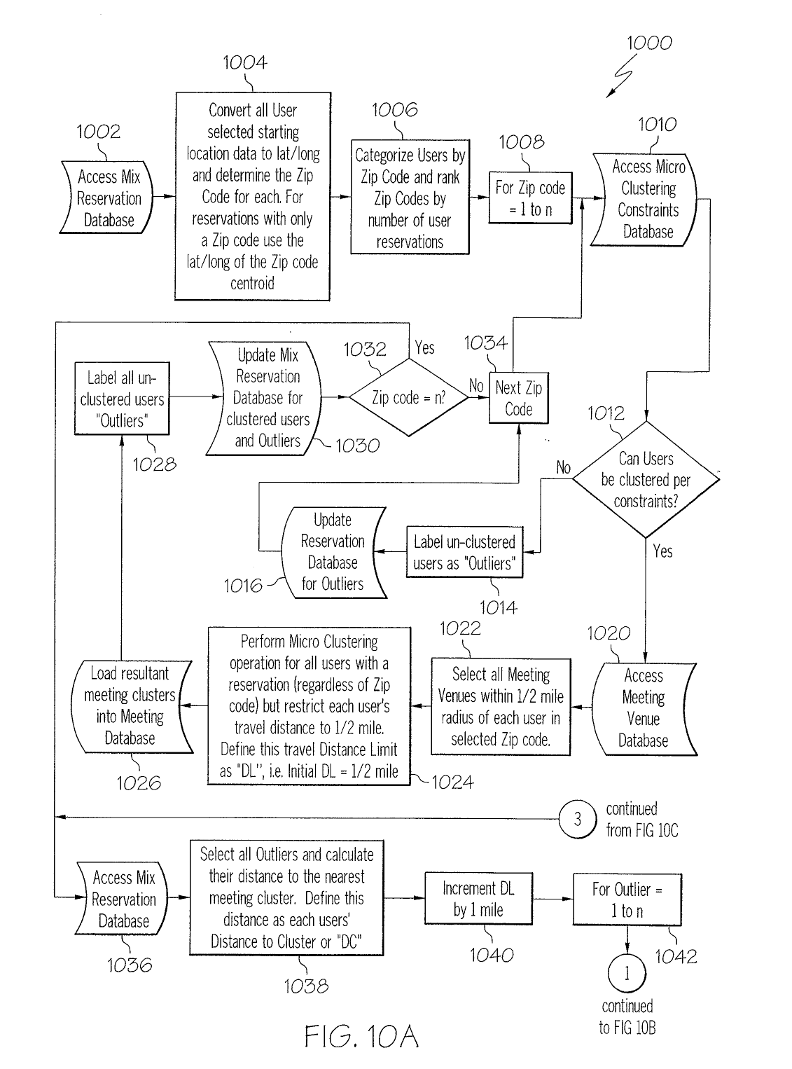

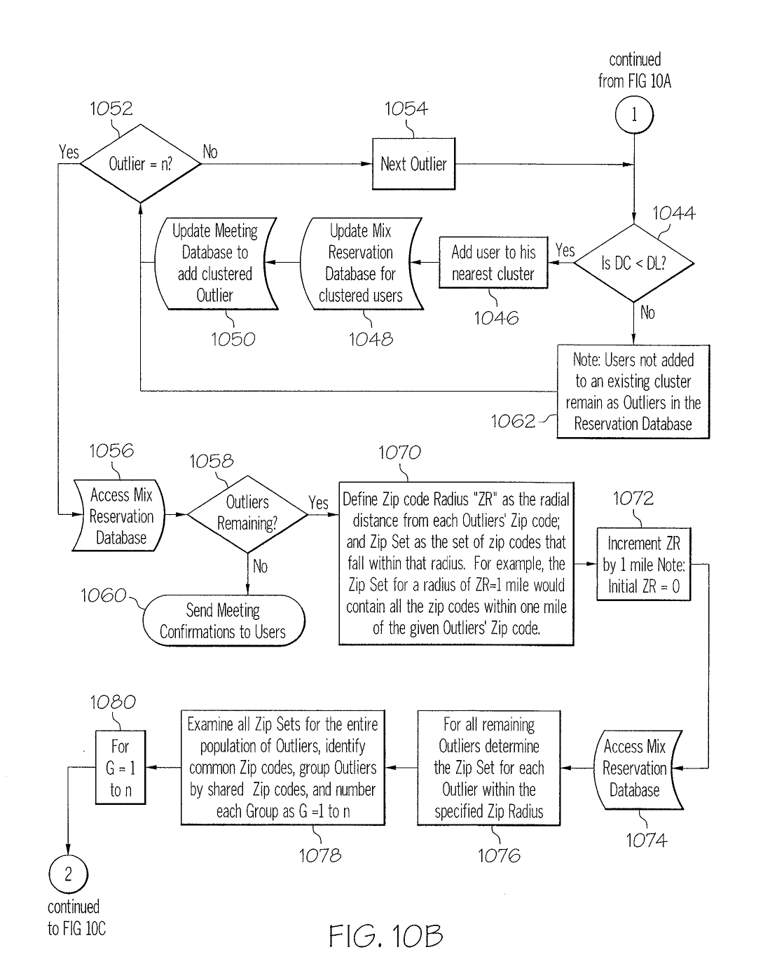

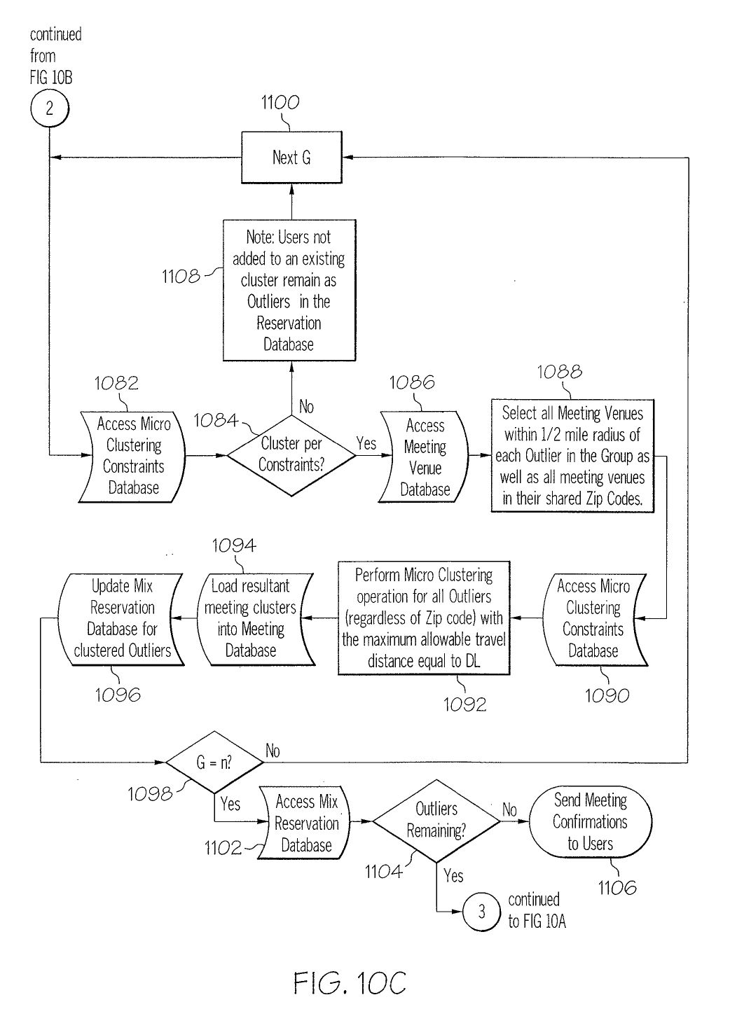

FIG. 10 is a flowchart 1000 depicting an embodiment of a clustering method that can be implemented by geographic clustering engine 206 of FIG. 2B. Those skilled in the art will appreciate the method of flowchart 1000 could be altered, or other methods could be used without departing from the spirit and scope of the present invention. Referring to FIG. 10, in step 1002, users access the clustering system 30 to input reservations, which can include a reservation database within storage device 44 (e.g., as part of meeting database 246). In step 1004, the clustering engine 206 categorizes users by zip code. In step 1006, zip codes are ranked by number of user reservations, e.g., for zip codes 1-n, in step 1008. In step 1010, constraints (or criteria) database, which can form part of meeting database 246, as an example) is accessed for determining meeting constraints, i.e., to be used for clustering users.

In step 1012, a determination is made of whether users in a given zip code can be clustered according to relevant meeting constraints. If the answer is “no”, the un-clustered users are labeled as “outliers,” step 1014. In step 1016, the reservation database is updated to record the outliers and the process moves to step 1034, hereafter described. If the answer in step 1012 was “yes,” then the method continues to access the map and venue database 244, in step 1020, which can include each venue's location in latitude and longitude. In step 1022, all meeting venues within a ½ mile radius of each user's starting location in a selected zip code are selected. In step 1024, “micro” clustering is done for all users (regardless of zip code), restricting each user's travel distance to ½ mile. In this step this travel distance limit is denoted as DL, where DL=½ mile. Micros clustering is localized clustering based on relevant meeting constraints, in this embodiment. In step 1026, the resultant meeting clusters are loaded into the meeting database. In step 1028, all unclustered users are labeled as outliers, and the reservation database is updated accordingly, in step 1030. In step 1032, if the zip code does not yet equal n, the next zip code is chosen, in step 1034, and the process returns to step 1010.

If, in step 1032, if the zip code was equal to n, then all zip codes have been considered and the process continues to step 1036, where the reservation database is accessed. In step 1038, all outliers are selected and their distances to the nearest clustered meeting is calculated. Each user's distance is denoted as his DC. In step 1040, DL is incremented by 1 mile. In step 1042, each outlier is denoted as being one of a group of 1-n. In step 1044, a determination is made of whether DC<D1 for the outlier.

If, in step 1044, DC is less than DL, the outlier/user is added to the cluster in step 1046. In step 1048, the reservation database is updated accordingly. In step 1050, the meeting database is updated to add the clustered outlier, and the process moves to step 1052. In step 1044, if DC was not less than DL, the users not added to an existing cluster remain as outliers in the reservation database, in step 1062, and the process continues to step 1052.

In step 1052, a determination is made of whether the outlier is outlier number n. If the determination is “no” then the next outlier is chosen in step 1054, and the process continues for that outlier. If, in step 1052, the determination was “yes,” that the outlier was outlier n, then the process continues to step 1056, where the reservation database is accessed. In step 1058, a determination is made of whether there are any remaining outliers. If the answer is “no,” then the process continues to step 1060, where confirmations are sent to the users.

In step 1058 if the determination was “yes,” the process continues to step 1070, where a zip code radius (ZR) is defined as the radial distance from each outlier's zip code and a zip code set is determined as the set of zip codes that fall within the radius. For example, an outlier's zip set for a radius of ZR=1 mile would contain all of the zip codes within 1 mile of the given outlier's zip code. In step 1072, ZR is incremented by 1 mile, and is initially 0. In step 1074, the reservation database is accessed. In step 1076, for all remaining outliers, the zip set for each outlier within the specified zip radius is determined. In step 1078, an examination of all zip sets is performed for the entire population of outliers. Common zip codes are identified and outliers are grouped by shared zip codes, and each group (G) is numbered, G=1 to n.

In step 1080 a group is chosen, i.e., from groups 1 to n. The process proceeds to step 1082, where the constraints database is accessed (as in step 1010). In step 1084, a determination is made of whether there are enough users that can be micro clustered into a meeting that complies with the meeting constraints. If the determination is “yes,” map & venue database 244 is accessed to determine a meeting location, in step 1086. In step 1088, venues within a ½ mile radius of each outlier in each group G are determined, as well as meeting venues in their zip codes. In step 1090 the constraints database is accessed. In step 1092, micro clustering is performed for all outliers, regardless of zip code and with maximum allowable travel distance equal to DL. In step 1094, the meeting clusters are stored in meeting database 246 and the reservation database is updated for clustered outliers, in step 1096.

In step 1098, a determination of whether G=n is made. If the answer is “yes,” then the process continues to step 1102 to access the reservation database. Next, in step 1104, a determination is made of whether there are outliers remaining. If the answer is “no,” in step 1106 meeting confirmations are sent to the users clustered for meetings. If the answer is in step 1104 is “yes,” then the process continues to step 1036, previously discussed. If the determination in step 1098 was “no” then the process continues to step 1100, where a next G is obtained, and then step 1082 is performed for the next group, as previously discussed.

Returning to step 1084, if users could not be clustered per relevant constraints, the process continues to step 1108, where users in unclustered groups remain as outliers in the reservation database. The process then moves to step 1100 and begins again with the next group, as previously discussed.

While the above method attempts to cluster all users, the clustering method need not be required to do so. That is, it is not necessary that all users be clustered in some embodiments. Also, in other countries information similar to zip codes can be used, e.g., if those countries do not use zip codes per se. Also, the clustering methodology can be applied nationwide, e.g., using time zones only. In various embodiments, geographical and political boundaries (e.g., state, city, county, and town boundaries) can or cannot be considered in clustering. In other words, in an embodiment that uses a radial search centered about each individual's starting location, such as that in FIG. 10, the method need not consider such boundaries.

While the foregoing has described what are considered to be the best mode and/or other preferred embodiments, it is understood that various modifications can be made therein and that the invention or inventions can be implemented in various forms and embodiments, and that they can be applied in numerous applications, only some of which have been described herein. It is also understood that while the embodiment researched here related to singles social clustering, implementations for other types of meetings are within the scope of the present invention.

What is claimed is:

1. A method of providing an interactive user interface to an automated meeting system, the method comprising:
storing meeting data including user identifications representing a set of users associated with a meeting;
generating for presentation via a user device at least a portion of the meeting data, including one or more of the user identifications; and
generating for presentation via the user device one or more communication mechanisms configured to enable double-blind communication with at least one user corresponding to at least one of the user identifications, wherein the one or more communication mechanisms includes mechanisms configured to generate a semi-formatted message, from a set of selectable semi-formatted messages, for transmission to the at least one user.

2. The method of claim 1, further comprising:
generating for presentation via the user device a blocking mechanism configured to enable the user to identify one or more of the set of users from which communications are to be prevented.

3. The method of claim 1, wherein the double-blind communication includes one or more of an e-mail, an instant message, a Web posting, a voice call, and a voice mail.

4. The method of claim 1, wherein the semi-formatted message is a preformatted invitation to a subsequent meeting.

5. The method of claim 1, wherein the semi-formatted message includes editable text.

6. The method of claim 1, wherein the semi-formatted message includes a reference to the meeting.

7. The method of claim 1, wherein the communication includes an image of the user sending the communication.

8. The method of claim 1, wherein the each of the one or more user identifications includes an image of a corresponding user.

9. The method of claim 1, further including:
generating for presentation meeting data including meeting history information of a user, the meeting history data including, for each meeting attended by the user, user identifications of other users that also attended each meeting.

10. The method of claim 9, wherein the user identifications are provided as selectable icons, and the method includes:
generating for presentation options for selecting the semi-formatted message addressed to an intended recipient, from the set of semi-formatted messages, in response to the user selecting an icon representing the intended recipient from the selectable icons.

11. An interactive user interface system configured to generate automated meeting scheduling outputs, the system comprising:
one or more data storage devices coupled to one or more computer processors that are accessible via a network;
a computer program product stored in the one or more storage devices and configured to be executed by the one or more computer processors to perform a method comprising:
storing meeting data including user identifications representing a set of users associated with a meeting;
generating for presentation via a user device at least a portion of the meeting data, including one or more of the user identifications; and
generating for presentation via the user device one or more communication mechanisms configured to enable double-blind communication with at least one user corresponding to at least one of the user identifications, wherein the one or more communication mechanisms includes mechanisms configured to generate a semi-formatted message, from a set of selectable semi-formatted messages, for transmission to the at least one user.

12. The system of claim 11, wherein the method further comprises:
generating for presentation via the user device a blocking mechanism configured to enable the user to identify one or more of the set of users from which communications are to be prevented.

13. The system of claim 11 wherein the double-blind communication includes one or more of an e-mail, an instant message, a Web posting, a voice call, and a voice mail.

14. The system of claim 11, wherein the semi-formatted messages is a preformatted invitation to a subsequent meeting.

15. The system of claim 11, wherein the semi-formatted message includes editable text.

16. The system of claim 11, wherein the semi-formatted message includes a reference to the meeting.

17. The system of claim 11, wherein the communication includes an image of the user sending the communication.

18. The system of claim 11, wherein the each of the one or more user identifications includes an image of a corresponding user.

19. The system of claim 11, wherein the method further comprises:
generating for presentation meeting data including meeting history information of a user, the meeting history data including, for each meeting attended by the user, user identifications of other users that also attended each meeting.

20. The system of claim 19, wherein the user identifications are provided as selectable icons, and the method includes:
generating for presentation options for selecting the semi-formatted message addressed to an intended recipient, from the set of semi-formatted messages, in response to the user selecting an icon representing the intended recipient from the selectable icons.
